(19) United States
(12) Patent Application Publication
(10) Pub. No.: US 2014/0244232 A1
(43) Pub. Date: Aug. 28, 2014

(54) SIMULATION APPARATUS AND SIMULATION METHOD

(71) Applicant: Mitsubishi Electric Corporation, Chiyoda-ku (JP)

(72) Inventors: Yoshihiro OGAWA, Tokyo (JP); Yusuke SHIMAI, Tokyo (JP)

(73) Assignee: Mitsubishi Electric Corporation, Chiyoda-ku (JP)

(21) Appl. No.: 14/187,581

(22) Filed: Feb. 24, 2014

(30) Foreign Application Priority Data
Feb. 28, 2013 (JP) 2013-038782
Oct. 4, 2013 (JP) 2013-209541

(51) Int. Cl. G06F 17/50

(52) U.S. Cl. CPC G06F 17/5009
USPC 703/14

(57) ABSTRACT

A simulation apparatus performs a simulation of a program for executing a plurality of instructions included in an instruction set of a processor. A bus model unit accepts an access request to a memory storing the program, performs arbitration for a bus, and calculates a cycle count of the processor until use of the bus is granted, for each instruction of the program. A cycle count accumulation unit computes a cycle count required for executing the program based on the cycle count for each instruction calculated by the bus model unit.

### CROSS-REFERENCE TO RELATED APPLICATIONS

This application is based on and claims the benefit of priority from Japanese Patent Applications No. 2013-038782, filed in Japan on Feb. 28, 2013, and No. 2013-209541, filed in Japan on Oct. 4, 2013, the content of which is incorporated herein by reference in its entirety.

### TECHNICAL FIELD

The present invention relates to a simulation apparatus, a simulation method, and a program.

### BACKGROUND ART

With the development of electronics in recent years, high-performance processors are in widespread use. In sophisticated systems such as information appliances in the consumer electronics field, system LSIs (Large Scale Integration) have been developed and used for miniaturization, higher performance, and cost reduction. (The term “LSI” is used herein to generally mean an integrated circuit including VLSI (Very Large Scale Integration) or the like.) In recent years, a system LSI has become a complex large-scale system composed of a processor, a memory, a cache memory, a bus, a hardware engine and so on. There has been an increased demand for performance evaluation of a system LSI using simulations in the design stage in order to check whether the system LSI being developed is capable of achieving desired performance.

In recent years, as a hardware design method, register-transfer level (RTL) design using a hardware description language such as Verilog-HDL (Hardware Description Language) or VHDL (Very-high-speed-integrated-circuits Hardware Description Language) is in widespread use. The use of the hardware description language allows a clock, a flip-flop, a register, an arithmetic unit and so on to be described at a logic circuit level, so that a simulation of detailed operations of hardware can be performed at a clock level.

However, it has been a problem that the simulation speed is slow and a simulation of large-scale software in a large-scale system LSI requires a vast amount of time.

For processors to be mounted on a conventional system LSI, an instruction set simulator (ISS) that executes an instruction set as a stream of instructions is generally known. In general, the instruction set simulator is developed to allow a software engineer or programmer to debug a program prior to obtaining the hardware to be developed.

FIG. 7 is a block diagram showing a configuration of an instruction set simulator 700 of a general type.

In FIG. 7, the instruction set simulator 700 includes an instruction decode/execution unit 800, a cycle count accumulation unit 801, and a memory access unit 802.

A simulation is started after program code 803 is stored in a memory 804.

The instruction decode/execution unit 800 loads via the memory access unit 802 an instruction in the program code 803 stored in the memory 804, parses the content of the instruction, and prepares information required for execution. Then, the instruction decode/execution unit 800 executes the parsed instruction. If a memory access occurs, the instruction decode/execution unit 800 loads data from the memory 804 or stores data to the memory 804 via the memory access unit 802.

Based on a type, a repeat count of arithmetic processing, and a basic memory access latency of the executed instruction, the instruction decode/execution unit 800 calculates a cycle count (number of cycles) required for execution of one instruction, and passes the cycle count to the cycle count accumulation unit 801. The cycle count accumulation unit 801 accumulates cycle counts received from the instruction decode/execution unit 800, and thereby calculates a cycle count required from start of the simulation.

With such a configuration, the instruction set simulator 700 can estimate instruction execution time by calculating and accumulating a cycle count required for execution of each instruction with consideration given to arithmetic processing time and a memory access latency of each instruction to be executed, and state of an instruction queue.

The instruction set simulator 700 is based on a concept with a high level of abstraction with no pipeline architecture or cycle-level accurate operations as in hardware. Thus, the instruction set simulator 700 can execute a simulation faster compared with the hardware description language such as Verilog-HDL or VHDL.

However, since a predetermined execution cycle count is used for each instruction without consideration given to operating environment conditions such as bus contention, it has been a problem that the simulation speed is fast but estimated execution time is not accurate.

On the other hand, there is a method that enables cycle-level accurate hardware verification not possible with the instruction set simulator and enhances the execution speed of RTL (for example, see Patent Literature 1). This method employs a processor model in which operations of a processor are condensed into three stages, namely, a fetch stage, an execution stage, and a memory and write-back stage, and wait control is performed in each stage as appropriate. Data communicated between the processor model and an external bus model is defined as a transaction. The processor model passes to the bus model information including a bus use request, an address, a data transfer amount, and a read/write classification. When use of the bus is granted by the bus model, the processor model transfers the transaction as a package.

### CITATION LIST

### Patent Literature

Patent Literature 1: JP 2006-318209 A

### SUMMARY OF INVENTION

### Technical Problem

In the conventional method described above, it is a problem that the simulation execution speed is faster compared with the hardware description language such as Verilog-HDL or VHDL, but a plurality of stages need to be executed in parallel, so that the speed is slower than the instruction set simulator of the general type.

It is also necessary to develop a simulator for system verification separately from the instruction set simulator for debugging software because the internal configuration greatly differs from that of the instruction set simulator.

It is an object of the present invention, for example, to provide a simulation apparatus capable of measuring an execution cycle count with consideration given to operating environment conditions such as bus contention, and achieving a fast simulation execution speed.

### Solution to Problem

A simulation apparatus according to one aspect of the present invention performs a simulation of a program for executing a plurality of instructions included in an instruction set of a processor, and the simulation apparatus includes:

a bus model unit that accepts an access request to a memory storing the program, performs a simulation of arbitration for a bus, and calculates a cycle count of the processor until use of the bus is granted, for each instruction of the program; and

a cycle count accumulation unit that computes a cycle count required for executing the program based on the cycle count for each instruction calculated by the bus model unit.

### Advantageous Effects of Invention

According to one aspect of the present invention, it is possible to provide a simulation apparatus capable of measuring an execution cycle count with consideration given to operating environment conditions such as bus contention, and achieving a fast simulation execution speed.

### BRIEF DESCRIPTION OF DRAWINGS

The present invention will become fully understood from the detailed description given hereinafter in conjunction with the accompanying drawings, in which:

FIG. 1 is a block diagram showing a configuration of a simulation apparatus according to a first embodiment;

FIG. 2 is a table showing an example of instruction cycle count information stored in an instruction information database according to the first embodiment;

FIG. 3 is a timing diagram showing an example of timings of operations of the simulation apparatus according to the first embodiment;

FIG. 4 is a block diagram showing a configuration of the simulation apparatus according to a second embodiment;

FIG. 5 is a table showing an example of memory access latencies stored in a memory access latency database according to the second embodiment;

FIG. 6 is a diagram showing an example of a hardware configuration of the simulation apparatus according to the first and second embodiments; and

FIG. 7 is a block diagram showing a configuration of an instruction set simulator of a general type.

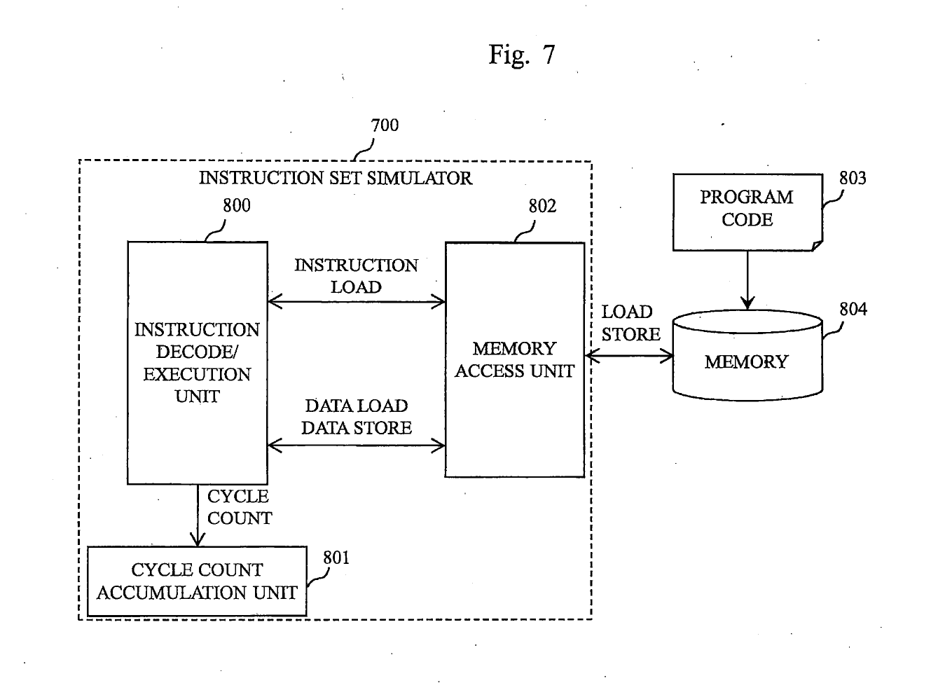

### DESCRIPTION OF EMBODIMENTS

In describing preferred embodiments illustrated in the drawings, specific terminology is employed for the sake of clarity. However, the disclosure of the present invention is not intended to be limited to the specific terminology so selected, and it is to be understood that each specific element includes all technical equivalents that operate in a similar manner and achieve a similar result.

Embodiments of the present invention will now be described using the drawings.

### First Embodiment

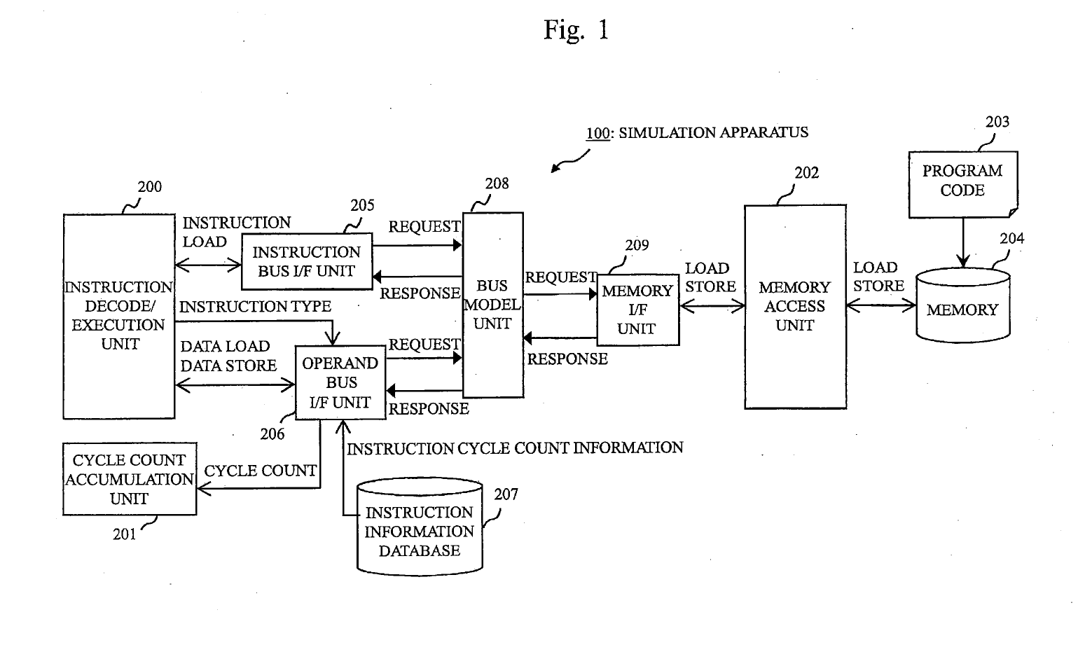

FIG. 1 is a block diagram showing a configuration of a simulation apparatus 100 according to this embodiment.

In FIG. 1, the simulation apparatus 100 includes an instruction decode/execution unit 200, a cycle count accumulation unit 201, a memory access unit 202, an instruction bus I/F unit 205 (instruction bus interface unit), an operand bus I/F unit 206 (operand bus interface unit), an instruction information database 207, a bus model unit 208, and a memory I/F unit 209 (memory interface unit).

In addition to a memory 204, the simulation apparatus 100 also includes hardware not illustrated such as a processor, an input device, an output device, and a storage device other than the memory 204. The hardware is used by each unit of the simulation apparatus 100. For example, the processor is used to calculate, process, read, and write data and information in each unit of the simulation apparatus 100, and so on. The memory 204 and the storage device other than the memory 204 are used to store the data and information. The input device is used to input the data and information, and the output device is used to output the data and information.

The simulation apparatus 100 performs a simulation of program code 203 through operations of each unit. The program code 203 is a program for executing a plurality of instructions included in an instruction set of the processor. As the program code 203, the memory 204 stores data of each instruction of the program code 203 and data of an operand used in each instruction of the program code 203.

The instruction decode/execution unit 200 performs (inputs) to the instruction bus I/F unit 205 and the operand bus I/F unit 206 access requests to the memory 204 for executing the instructions of the program code 203, in a sequence specified in the program code 203. After the instruction decode/execution unit 200 performs to the instruction bus I/F unit 205 or the operand bus I/F unit 206 an access request to the memory 204 and then a response is returned from the instruction bus I/F unit 205 or the operand bus I/F unit 206 (request destination), the instruction decode/execution unit 200 performs (inputs) to the instruction bus I/F unit 205 or the operand bus I/F unit 206 an access request to the memory 204 for executing a next instruction of the program code 203.

Using the storage device, the instruction information database 207 has prestored therein a cycle count (number of cycles) of the processor required for executing an instruction for each type of instruction included in the instruction set of the processor.

The instruction bus I/F unit 205, which is an example of a bus interface unit, accepts from the instruction decode/execution unit 200 as an access request to the memory 204 a load request for data of an instruction of the program code 203, and performs (inputs) the load request to the bus model unit 208, for each instruction of the program code 203. After the instruction bus I/F unit 205 performs to the bus model unit 208 the load request for data of the instruction of the program code 203 and then a response is returned from the bus model unit 208, the instruction bus I/F unit 205 returns (inputs) the response to the instruction decode/execution unit 200.

The operand bus I/F unit 206, which is an example of the bus interface unit, accepts from the instruction decode/execution unit 200 as an access request to the memory 204 a load request or store request for data of an operand used in an instruction of the program code 203, and extracts from the instruction information database 207 a cycle count corresponding to the type of the instruction, for each instruction of the program code 203. When the operand bus I/F unit 206 accepts from the instruction decode/execution unit 200 the load request or store request for data of the operand used in the instruction of the program code 203, the operand bus I/F unit 206 also performs (inputs) the load request or store request to the bus model unit 208. After the operand bus I/F unit 206 performs to the bus model unit 208 the load request or store request for data of the operand used in the instruction of the program code 203 and then a response is returned from the bus model unit 208, the operand bus I/F unit 206 returns (inputs) the response to the instruction decode/execution unit 200.

The bus model unit 208 accepts from the instruction bus I/F unit 205 and the operand bus I/F unit 206 access requests to the memory 204, performs a simulation of bus arbitration, and calculates a cycle count of the processor until use of the bus is granted, for each instruction of the program code 203. When the bus model unit 208 accepts from the instruction bus I/F unit 205 or the operand bus I/F unit 206 an access request to the memory 204, the bus model unit 208 also performs (inputs) the access request to the memory I/F unit 209 without waiting until use of the bus is granted. After the bus model unit 208 performs to the memory I/F unit 209 the access request to the memory 204 and then a response is returned from the memory I/F unit 209, the bus model unit 208 returns (inputs) the response to the instruction bus I/F unit 205 or the operand bus I/F unit 206 (request source).

The memory I/F unit 209 accepts from the bus model unit 208 an access request to the memory 204, and outputs an access delay (access latency) to the memory 204 as a predetermined cycle count of the processor, for each instruction of the program code 203. When the memory I/F unit 209 accepts from the bus model unit 208 an access request to the memory 204, the memory I/F unit 209 also accesses the memory 204 via the memory access unit 202. Specifically, if the memory I/F unit 209 accepts a load request for data of an instruction of the program code 203 as the access request to the memory 204, the memory I/F unit 209 loads the data of the instruction from the memory 204. If the memory I/F unit 209 accepts a load request for data of an operand used in an instruction of the program code 203 as the access request to the memory 204, the memory I/F unit 209 loads the data of the operand from the memory 204. If the memory I/F unit 209 accepts a store request for data of an operand used in an instruction of the program code 203 as the access request to the memory 204, the memory I/F unit 209 stores the data of the operand to the memory 204. After accessing the memory 204, the memory I/F unit 209 returns (inputs) a response to the bus model unit 208.

The cycle count accumulation unit 201 computes a cycle count required for executing the program code 203 based on the cycle count for each instruction calculated by the bus model unit 208. Preferably, the cycle count accumulation unit 201 computes the cycle count required for executing the program code 203 based on the cycle count for each instruction extracted by the operand bus I/F unit 206 and/or the cycle count for each instruction output by the memory I/F unit 209, in addition to the cycle count for each instruction calculated by the bus model unit 208. Using the output device, the cycle count accumulation unit 201 outputs the computed cycle count.

Detailed operations of each unit of the simulation apparatus 100 will now be described.

A simulation is started after the program code 203 is stored in the memory 204.

The instruction decode/execution unit 200 requests to the instruction bus I/F unit 205 an instruction load from the program code 203 stored in the memory 204. In response to the designated instruction load, the instruction bus I/F unit 205 requests to the bus model unit 208 a data load from the memory 204. The bus model unit 208 performs bus arbitration for the designated data load request. If the bus is being used or there is a request with higher priority than the request from the instruction bus I/F unit 205, the bus model unit 208 controls the request from the instruction bus I/F unit 205 to be put on hold. If the request from the instruction bus I/F unit 205 is granted use of the bus, the bus model unit 208 requests the data load to the memory I/F unit 209.

The memory I/F unit 209 receives the data load request from the bus model unit 208, and loads the data from the memory 204 via the memory access unit 202. The memory I/F unit 209 waits for a period of time corresponding to the cycle count of a memory access latency, and then returns a response to the bus model unit 208.

The bus model unit 208 receives the response from the memory I/F unit 209, and returns the response to the instruction bus I/F unit 205. Note that during a period after a memory access request is sent out to the memory I/F unit 209 until a response is returned, the bus model unit 208 regards the bus as being used and does not accept any new request.

The instruction bus I/F unit 205 receives the response from the bus model unit 208, and passes the loaded instruction data to the instruction decode/execution unit 200.

The instruction decode/execution unit 200 parses the loaded instruction data, and then executes the instruction. The instruction decode/execution unit 200 first notifies a type of the instruction to be executed to the operand bus I/F unit 206. Then, each time a load instruction or store instruction for operand data is executed, the instruction decode/execution unit 200 requests to the operand bus I/F unit 206 a data load from the memory 204 or a data store to the memory 204. When execution of one instruction is completed, the instruction decode/execution unit 200 proceeds to a decode process of a next instruction.

The operand bus I/F unit 206 is notified of the type of the instruction by the instruction decode/execution unit 200, and obtains from the instruction information database 207 cycle count information of the instruction to be executed. The operand bus I/F unit 206 performs wait control in accordance with the cycle count information, and thereby adjusts the memory access timing and the timing to start the decode process of the next instruction.

The operand bus I/F unit 206 receives the designated data load or data store, and requests the bus model unit 208 the data load from the memory 204 or the data store to the memory 204. The bus model unit 208 performs bus arbitration for the designated data load or data store request. If the bus is being used or there is a request with higher priority than the request from the operand bus I/F unit 206, the bus model unit 208 controls the request from the operand bus I/F unit 206 to be put on hold. If use of the bus is granted to the request from the operand bus I/F unit 206, the bus model unit 208 requests the data load or data store to the memory I/F unit 209.

The memory I/F unit 209 receives the data load or data store request from the bus model unit 208, and loads the data from the memory 204 or stores the data to the memory 204 via the memory access unit 202. The memory I/F unit 209 waits for a period of time corresponding to the cycle count of a memory access latency, and then returns a response to the bus model unit 208.

The bus model unit 208 receives the response from the memory I/F unit 209, and returns the response to the operand bus I/F unit 206. Note that during a period after a memory access request is sent out to the memory I/F unit 209 until a response is returned, the bus model unit 208 regards the bus as being used and does not accept any new request.

The operand bus I/F unit 206 receives the response from the bus model unit 208, and passes the loaded operand data to the instruction decode/execution unit 200, or notifies to the instruction decode/execution unit 200 completion of storing the operand data.

The operand bus I/F unit 206 notifies to the cycle count accumulation unit 201 a cycle count required for executing one instruction, that is, the cycle count used for hold control by the bus model unit 208, wait control by the memory I/F unit 209 or wait control by the operand bus I/F unit 206. The cycle count accumulation unit 201 accumulates the cycle counts notified by the operand bus I/F unit 206, and thereby calculates a cycle count required from start of the simulation.

In this embodiment, the instruction bus I/F unit 205 and the operand bus I/F unit 206 have a function of generating a bus access timing at a cycle level from a memory access process with no concept of time that occurs during execution of a simulation. The bus model unit 208 can execute a simulation of bus accesses at the cycle level.

Further, the memory I/F unit 209 converts a bus access timing at the cycle level into a memory access process with no concept of time, and accesses the memory 204 via the memory access unit 202.

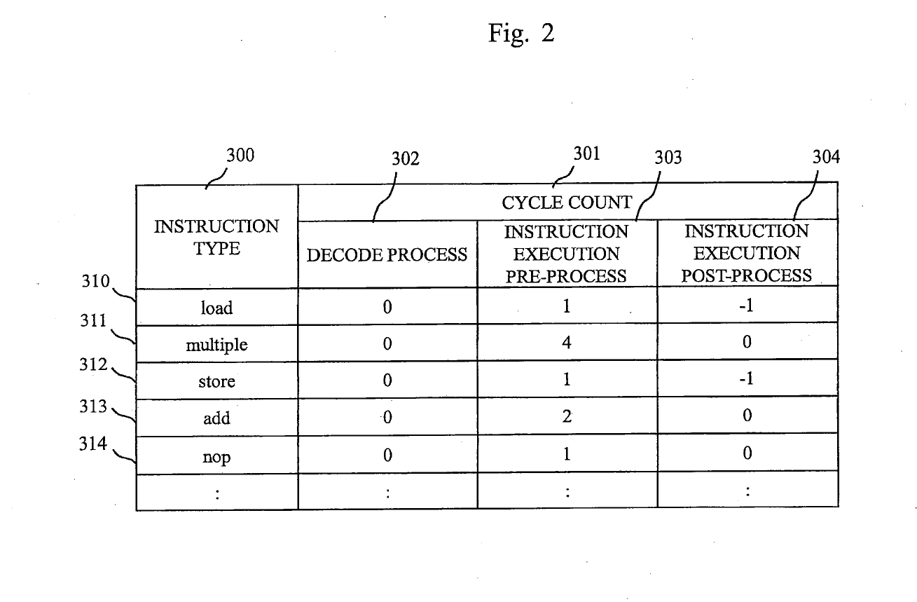

FIG. 2 is a table showing an example of instruction cycle count information stored in the instruction information database 207.

In FIG. 2, the instruction information database 207 has columns for storing an instruction type 300 and a cycle count 301. The column of the cycle count 301 is divided into three columns for storing a cycle count of a decode process 302, a cycle count of an instruction execution pre-process 303, and a cycle count of an instruction execution post-process 304.

In this example, there are rows for storing cycle counts of a load instruction 310, cycle counts of a multiple instruction 311, cycle counts of a store instruction 312, cycle counts of an add instruction 313, and cycle counts of a nop instruction 314. Types of instructions are not limited to these five types, and it is preferable that all types of instructions included in the instruction set of the processor are covered.

In the table, a cycle count of “0” or greater represents a cycle count used for wait control, and “−1” signifies that a next process is started without waiting for completion of the process. In this table, the cycle count of the instruction execution post-process 304 of the load instruction 310 and the cycle count of the instruction execution post-process 304 of the store instruction 312 are “−1”, indicating that next instructions after the operand load of the load instruction and the operand store of the store instruction are started without waiting for completion of these processes, respectively.

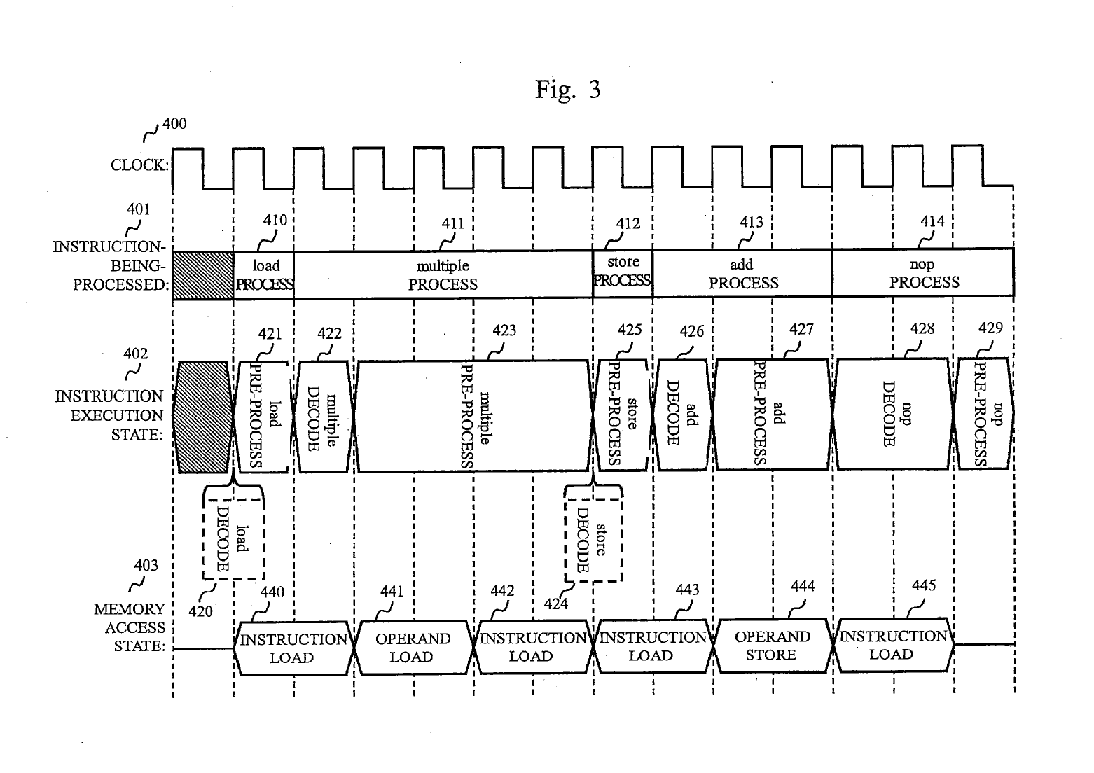

FIG. 3 is a timing diagram showing an example of timings of operations of the simulation apparatus 100.

FIG. 3 shows clock timings 400, an instruction-being-processed 401, timings of an instruction execution state 402, and timings of a memory access state 403 in a case where a simulation is performed with a memory access latency of 2 cycles and based on the cycle counts shown in FIG. 2.

In this example, instructions are executed in the order of a load instruction process 410, a multiple instruction process 411, a store instruction process 412, an add instruction process 413, and a nop instruction process 414.

In the load instruction process 410, processes are executed in the order of a load instruction decode process 420 and a load instruction pre-process 421. In the instruction information database 207, the cycle count of the decode process 302 of the load instruction 310 is 0 cycles. Thus, the load instruction decode process 420 ends in a period of 0 cycles. With the load instruction decode process 420, an instruction load 440 to the memory 204 occurs, and a fetch process of a next instruction is performed.

In the instruction information database 207, the cycle count of the instruction execution pre-process 303 of the load instruction 310 is 1 cycle and the cycle count of the instruction execution post-process 304 of the load instruction 310 is “−1”. Thus, the load instruction pre-process 421 continues for a period of 1 cycle, and then the load instruction process 410 ends. After completion of the load instruction pre-process 421, an operand load 441 to the memory 204 occurs. At the timing of completion of the load instruction pre-process 421, the memory 204 is being accessed by the instruction load 440, so that the operand load 441 is started after completion of the instruction load 440.

In the multiple instruction process 411, processes are executed in the order of a multiple instruction decode process 422 and a multiple instruction pre-process 423. In the instruction information database 207, the cycle count of the decode process 302 of the multiple instruction 311 is 0 cycles, and the memory 204 is being accessed by the instruction load 440 at start of the multiple instruction decode process 422. Thus, the multiple instruction decode process 422 continues until completion of the instruction load 440. With the multiple instruction decode process 422, an instruction load 442 to the memory 204 occurs, and a fetch process of a next instruction is performed. At the timing of completion of the multiple instruction decode process 422, the memory 204 is being accessed by the operand load 441, so that the instruction load 442 is started after completion of the operand load 441.

In the instruction information database 207, the cycle count of the instruction execution pre-process 303 of the multiple instruction 311 is 4 cycles and the cycle count of the instruction execution post-process 304 of the multiple instruction 311 is 0 cycles. Thus, the multiple instruction pre-process 423 continues for a period of 4 cycles, and then the multiple instruction process 411 ends.

In the store instruction process 412, processes are executed in the order of a store instruction decode process 424 and a store instruction pre-process 425. In the instruction information database 207, the cycle count of the decode process 302 of the store instruction 312 is 0 cycles. Thus, the store instruction decode process 424 ends in a period of 0 cycles. With the store instruction decode process 424, an instruction load 443 to the memory 204 occurs, and a fetch process of a next instruction is performed.

In the instruction information database 207, the cycle count of the instruction execution pre-process 303 of the store instruction 312 is 1 cycle. Thus, the store instruction pre-process 425 continues for a period of 1 cycle. After completion of the store instruction pre-process 425, an operand store 444 occurs. At the timing of completion of the store instruction pre-process 425, the memory 204 is being accessed by the instruction load 443, so that the operand store 444 to the memory 204 is started after completion of the instruction load 443. In the instruction information database 207, the cycle count of the instruction execution post-process 304 of the store instruction 312 is “−1”. Thus, the store instruction process 412 ends with completion of the store instruction pre-process 425.

In the add instruction process 413, processes are executed in the order of an add instruction decode process 426 and an add instruction pre-process 427. In the instruction information database 207, the cycle count of the decode process 302 of the add instruction 313 is 0 cycles, but an instruction fetch process at the instruction load 443 has not completed at the timing of start of the add instruction decode process 426. Thus, the add instruction decode process 426 continues for a period of 1 cycle until completion of the instruction load 443. With the add instruction decode process 426, an instruction load 445 to the memory 204 occurs, and a fetch process of a next instruction is performed. The operand store 444 to the memory 204 is started after completion of the add instruction decode process 426, so that the instruction load 445 to the memory 204 is started after completion of the operand store 444.

In the instruction information database 207, the cycle count of the instruction execution pre-process 303 of the add instruction 313 is 2 cycles and the cycle count of the instruction execution post-process 304 of the add instruction 313 is 0 cycles. Thus, the add instruction pre-process 427 continues for a period of 2 cycles, and then the add instruction process 413 ends.

In the nop instruction process 414, processes are executed in the order of a nop instruction decode process 428 and a nop instruction pre-process 429. In the instruction information database 207, the cycle count of the decode process 302 of the nop instruction 314 is 0 cycles, but an instruction fetch process at the instruction load 445 has not completed at the timing of start of the nop instruction decode process 428. Thus, the nop instruction decode process 428 continues for a period of 2 cycles until completion of the instruction load 445.

In the instruction information database 207, the cycle count of the instruction execution pre-process 303 of the nop instruction 314 is 1 cycle and the cycle count of the instruction execution post-process 304 of the nop instruction 314 is 0 cycles. Thus, the nop instruction pre-process 429 continues for a period of 1 cycle, and then the nop instruction process 414 ends.

Wait control that occurs in the instruction execution state 402 is performed by the operand bus I/F unit 206, and wait control that occurs in the memory access state 403 is performed by the memory I/F unit 209. In the example of FIG. 3, the load instruction process 410 uses 1 cycle, the multiple instruction process 411 uses 5 cycles, the store instruction process 412 uses 1 cycle, the add instruction process 413 uses 3 cycles, and the nop instruction process 414 uses 3 cycles. The cycle count used in each instruction process is sequentially transferred from the operand bus I/F unit 206 to the cycle count accumulation unit 201, and a total cycle count of 13 cycles is calculated by the cycle count accumulation unit 201.

In the example of FIG. 3, at completion of the load instruction process 410, the operand bus I/F unit 206 performs a request to the bus model unit 208 and the instruction decode/execution unit 200 starts processing of the next instruction without waiting for a response, so that the next multiple instruction process 411 is started without waiting for completion of the operand load 441. In this example, at the timing when the operand bus I/F unit 206 performs the request to the bus model unit 208, data loaded from the memory 204 is passed to the instruction decode/execution unit 200 to continue execution of the simulation and execute bus accesses simultaneously. With this arrangement, a simulation of parallel processing through pipelining of bus access processes is realized.

As described above, in this embodiment, it is possible to perform a simulation with cycle accuracy that takes into account contention among a memory access by an instruction load that occurs in instruction decode and memory accesses by an operand load and an operand store that occur in instruction execution.

As described above, the simulation apparatus 100 according to this embodiment is an apparatus that performs a simulation of an application program having a plurality of instruction sets, at an instruction set level in a processor. The simulation apparatus 100 generates a bus access timing at the cycle level from a memory access process with no concept of time that occurs during execution of a simulation and performs a simulation of bus accesses at the cycle level, and thereby calculates an instruction execution cycle count.

The simulation apparatus 100 has a plurality of types of the function of generating a bus access timing at the cycle level from a memory access process with no concept of time that occurs during execution of a simulation, for the purposes of loading instruction data and of loading and storing operand data.

The simulation apparatus 100 performs a memory access by converting a bus access timing at the cycle level into a memory access process with no concept of time.

When generating a bus access timing at the cycle level from a memory access process with no concept of time that occurs in execution of a simulation, the simulation apparatus 100 refers to a cycle count database arranged according to instruction types.

In generating a bus access timing at the cycle level from a memory access process with no concept of time that occurs during execution of a simulation and implementing the bus access timing at the cycle level, the simulation apparatus 100 executes the simulation by obtaining load data from the memory 204 and saving store data to the memory 204 before completion of the bus access.

According to this embodiment, it is possible to provide the simulation apparatus 100 that can achieve an execution speed comparable to that of an instruction set simulator of a general type.

According to this embodiment, it is possible to provide the simulation apparatus 100 that can be developed by employing development resources of the instruction set simulator of the general type, and that can measure an execution cycle count highly accurately.

### Second Embodiment

Regarding this embodiment, differences from the first embodiment will be primarily described.

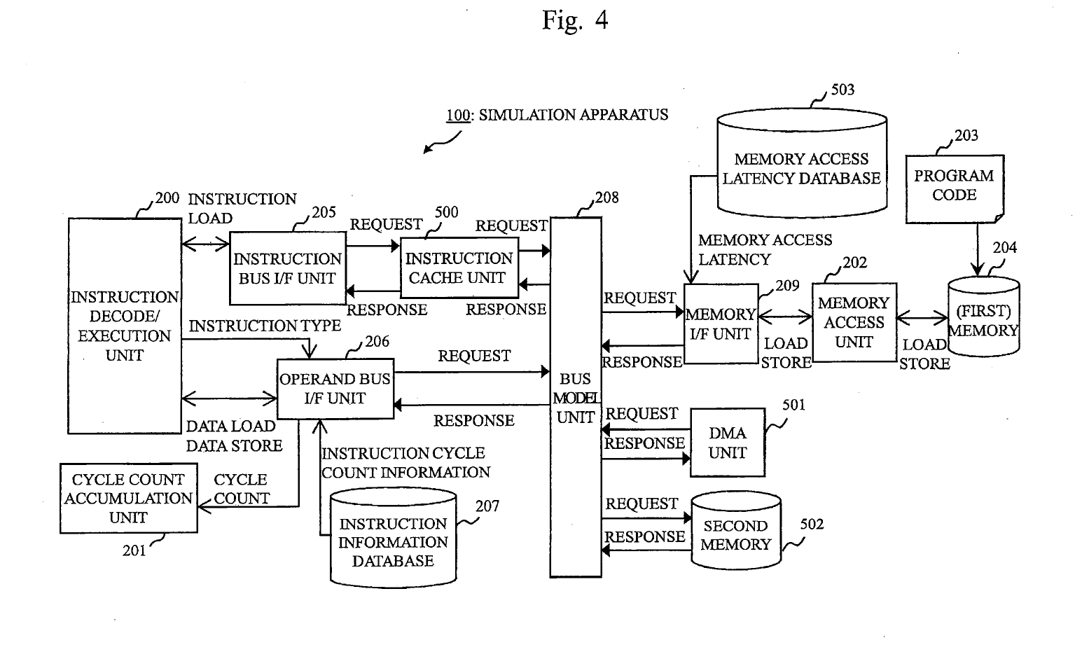

FIG. 4 is a block diagram showing a configuration of the simulation apparatus 100 according to this embodiment.

In FIG. 4, the simulation apparatus 100 includes an instruction cache unit 500 (data cache unit), a DMA unit 501 (direct memory access unit), and a memory access latency database 503, in addition to the units of the simulation apparatus 100 according to the first embodiment shown in FIG. 1.

The simulation apparatus 100 also includes a second memory 502 aside from the (first) memory 204.

The instruction cache unit 500 is provided between the instruction bus I/F unit 205 and the bus model unit 208, and functions as a cache for the memory 204.

The DMA unit 501 and the second memory 502 are connected to the bus model unit 208. The DMA unit 501 performs (inputs) to the bus model unit 208 an access request to directly transfer data between the memory 204 and the second memory 502.

The memory access latency database 503 is connected to the memory I/F unit 209, and using the storage device, stores a cycle count of the processor representing an access delay to the memory 204 for each address range of the memory 204.

When the operand bus I/F unit 206 accepts from the instruction decode/execution unit 200 a load request for data of an operand used in an instruction of the program code 203, the operand bus I/F unit 206 performs (inputs) the load request to the bus model unit 208 if the data of the operand is not stored in the instruction cache unit 500. On the other hand, if the data of the operand is stored in the instruction cache unit 500, the operand bus I/F unit 206 does not perform (input) the load request to the bus model unit 208, and returns (inputs) a response to the instruction decode/execution unit 200.

The bus model unit 208 accepts an access request to the memory 204 from the instruction bus I/F unit 205 and the operand bus I/F unit 206, and also accepts an access request to the memory 204 from the DMA unit 501, for each instruction of the program code 203. While one access request is being processed, the bus model unit 208 determines that the bus is being used.

The memory I/F unit 209 accepts an access request to the memory 204 from the bus model unit 208, extracts from the memory access latency database 503 a cycle count corresponding to the relevant address in the memory 204, and outputs the cycle count, for each instruction of the program code 203.

The instruction cache unit 500 is a temporary storage device of a general type for accelerating data accesses, and its cache algorithm may be implemented herein with any method. In this embodiment, the instruction cache unit 500 is implemented as a model capable of a simulation of bus accesses at the cycle level, and is incorporated in the simulation apparatus 100. With this arrangement, it is possible to measure a processing cycle count in a case where the instruction cache unit 500 is implemented.

The DMA unit 501 is a DMA device of a general type that directly transfers data between memories. The DMA unit 501 transfers data between the memory 204 and the second memory 502. In this embodiment, the DMA unit 501 and the second memory 502 are implemented as models capable of a simulation of bus accesses at the cycle level, and are incorporated in the simulation apparatus 100. With this arrangement, it is possible to measure a processing cycle count in a case where bus contention caused by a bus access from other than the processor.

The memory access latency database 503 is a device that stores a latency for a memory access. After receiving a request from the bus model unit 208, the memory I/F unit 209 waits for a period of time corresponding to the cycle count of a memory access latency according to data stored in the memory access latency database 503, and then returns a response to the bus model unit 208.

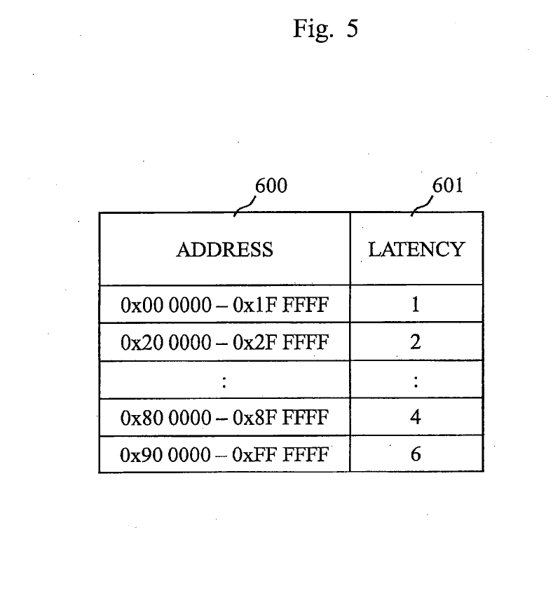

FIG. 5 is a table showing an example of memory access latencies stored in the memory access latency database 503.

In FIG. 5, the memory access latency database 503 has columns for storing an address range 600 of the memory 204 and an access latency 601 of the memory 204. Here, a different memory access latency is set for each address range of the memory 204. With such a configuration, it is possible to measure processing cycle counts under different memory access latency conditions.

As described above, the simulation apparatus 100 according to this embodiment generates a bus access timing at the cycle level from a memory access process with no concept of time that occurs during execution of a simulation, and then performs a memory access via a cache memory device capable of execution at the cycle level.

The simulation apparatus 100 includes a device, other than the processor, that performs a memory access with a bus access timing at the cycle level.

When converting a bus access timing at the cycle level into a memory access process with no concept of time and then performing a memory access, the simulation apparatus 100 refers to the memory access latency database 503.

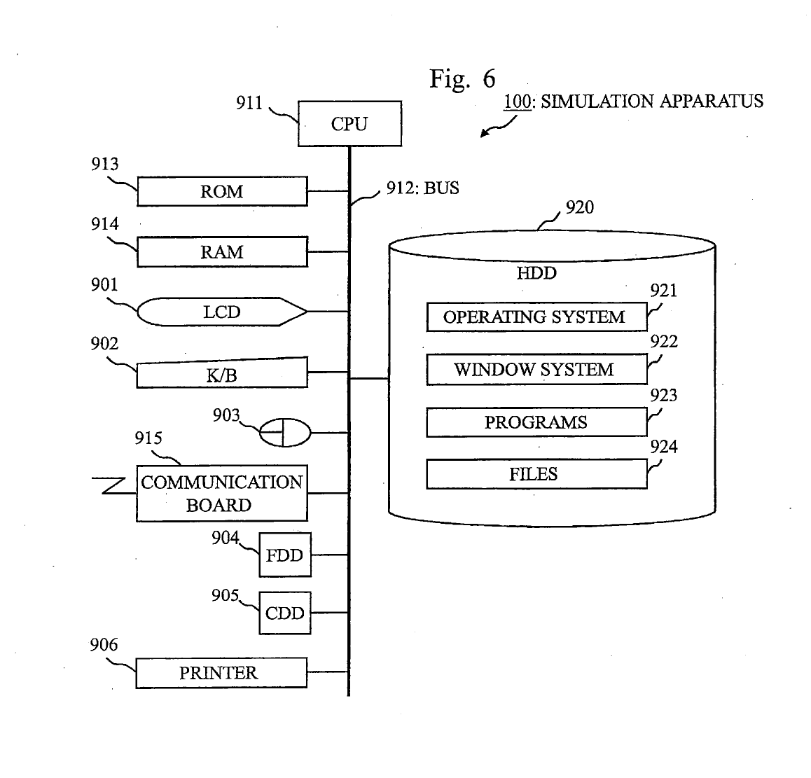

FIG. 6 is a diagram showing an example of a hardware configuration of the simulation apparatus 100 according to the first and second embodiments.

In FIG. 6, the simulation apparatus 100 is a computer, and includes hardware devices such as an LCD 901 (Liquid Crystal Display), a keyboard 902 (KB), a mouse 903, an FDD 904 (Flexible Disk Drive), a CDD 905 (Compact Disc Drive), and a printer 906. These hardware devices are connected via cables or signal lines. In place of the LCD 901, a CRT (Cathode Ray Tube) or other types of display device may be used. In place of the mouse 903, a touch panel, a touch pad, a track ball, a pen tablet, or other types of pointing device may be used.

The simulation apparatus 100 includes a CPU 911 (Central Processing Unit) that executes programs. The CPU 911 is an example of the processor. The CPU 911 is connected via a bus 912 to a ROM 913 (Read Only Memory), a RAM 914 (Random Access Memory), a communication board 915, the LCD 901, the keyboard 902, the mouse 903, the FDD 904, the CDD 905, the printer 906, and an HDD 920 (Hard Disk Drive), and controls these hardware devices. In place of the HDD 920, a flash memory, an optical disc drive, a memory card reader/writer, or other types of recording medium may be used.

The RAM 914 is an example of a volatile memory. The ROM 913, the FDD 904, the CDD 905, and the HDD 920 are examples of a non-volatile memory. These are examples of the memory 204 and the storage device other than the memory 204. The communication board 915, the keyboard 902, the mouse 903, the FDD 904, and the CDD 905 are examples of the input device. The communication board 915, the LCD 901, and the printer 906 are examples of the output device.

The communication board 915 is connected to a LAN (Local Area Network) or the like. The communication board 915 may be connected not only to the LAN but also to the Internet or a WAN (Wide Area Network) such as an IP-VPN (Internet Protocol Virtual Private Network), a wide-area LAN, or an ATM (Asynchronous Transfer Mode) network. The LAN, WAN, and Internet are examples of a network.

The HDD 920 stores an operating system 921 (OS), a window system 922, programs 923, and files 924. The programs 923 are executed by the CPU 911, the operating system 921, and the window system 922. The programs 923 include programs that execute functions described as “units” in the description of the embodiments. The programs are read and executed by the CPU 911. The files 924 contain, as entries of a “file”, a “database”, and a “table”, data, information, signal values, variable values, and parameters which are described in the description of the embodiments as “data”, “information”, an “ID (identifier)”, a “flag”, and a “result”. The “file”, “database”, and “table” are stored in a recording medium such as the RAM 914 or the HDD 920. The data, information, signal values, variable values, and parameters stored in the recording medium such as the RAM 914 or the HDD 920 are read by the CPU 911 to a main memory or a cache memory via a read/write circuit, and are used for processing (operation) of the CPU 911 such as extraction, search, reference, comparison, calculation, computation, control, output, printing, and display. During processing of the CPU 911 such as extraction, search, reference, comparison, calculation, computation, control, output, printing, and display, the data, information, signal values, variable values, and parameters are temporarily stored in the main memory, the cache memory, or a buffer memory.

The arrows in the block diagrams and flowcharts used in the description of the embodiments primarily denote inputs/outputs of data and signals. The data and signals are recorded in a memory such as the RAM 914, a flexible disk (FD) of the FDD 904, a compact disc (CD) of the CDD 905, a magnetic disk of the HDD 920, an optical disc, a DVD (Digital Versatile Disc), or other types of recording medium. The data and signals are transmitted by the bus 912, a signal line, a cable, or other types of transmission medium.

What is described as a “unit” in the description of the embodiments may be a “circuit”, “device”, “equipment”, and may also be a “step”, “procedure”, or “process”. That is, what is described as a “unit” may be realized by firmware stored in the ROM 913. Alternatively, what is described as a “unit” may be realized solely by software, or solely by hardware such as an element, a device, a substrate, or a wiring line. Alternatively, what is described as a “unit” may be realized by a combination of software and hardware, or a combination of software, hardware, and firmware. The firmware and software are stored as programs in a recording medium such as a flexible disk, a compact disc, a magnetic disk, an optical disc, or a DVD. The programs are read by the CPU 911 and are executed by the CPU 911. That is, each program causes the computer to function as each “unit” described in the description of the embodiments. Alternatively, each program causes the computer to execute a procedure or method of each “unit” described in the description of the embodiments.

The embodiments of the present invention have been described. Two or more of these embodiments may be implemented in combination. Alternatively, one of these embodiments may be partially implemented. Alternatively, two or more of these embodiments may be partially implemented in combination. The present invention is not limited to these embodiments, and various modifications are possible as required.

Numerous additional modifications and variations are possible in light of the above teachings. It is therefore to be understood that, within the scope of the appended claims, the disclosure of this patent specification may be practiced otherwise than as specifically described herein.

### REFERENCE SIGNS LIST

100: simulation apparatus
200, 800: instruction decode/execution unit
201, 801: cycle count accumulation unit
202, 802: memory access unit
203, 803: program code
204, 804: memory
205: instruction bus I/F unit
206: operand bus I/F unit
207: instruction information database
208: bus model unit
209: memory I/F unit
300: instruction type
301: cycle count
302: decode process
303: instruction execution pre-process
304: instruction execution post-process
310: load instruction
311 multiple instruction
312: store instruction
313: add instruction
314: nop instruction
400: clock timings
401: instruction-being-processed
402: instruction execution state
403: memory access state
410: load instruction process
411: multiple instruction process
412: store instruction process
413: add instruction process
414: nop instruction process
420: load instruction decode process
421: load instruction pre-process
422: multiple instruction decode process
423: multiple instruction pre-process
424: store instruction decode process
425: store instruction pre-process
426: add instruction decode process
427: add instruction pre-process
428: nop instruction decode process
429: nop instruction pre-process
440, 442, 443, 445: instruction load
441: operand load
444: operand store
500: instruction cache unit
501: DMA unit
502: second memory
503: memory access latency database
600: address range
601: access latency
700: instruction set simulator
901: LCD
902: keyboard
903: mouse
904: FDD
905: CDD
906: printer
911: CPU
912: bus
913: ROM
914: RAM
915: communication board
920: HDD
921: operating system
922: window system
923: programs
924: files

1. A simulation apparatus that performs a simulation of a program for executing a plurality of instructions included in an instruction set of a processor, the simulation apparatus comprising:
a bus model unit that accepts an access request to a memory storing the program, performs a simulation of arbitration for a bus, and calculates a cycle count of the processor until use of the bus is granted, for each instruction of the program; and
a cycle count accumulation unit that computes a cycle count required for executing the program based on the cycle count for each instruction calculated by the bus model unit.

2. The simulation apparatus according to claim 1, further comprising:
an instruction information database that stores a cycle count of the processor required for executing an instruction for each type of instruction included in the instruction set; and
a bus interface unit that accepts an access request to the memory, and extracts from the instruction information database a cycle count corresponding to a type of an instruction, for each instruction of the program,
wherein the cycle count accumulation unit computes the cycle count required for executing the program based on the cycle count for each instruction extracted by the bus interface unit, in addition to the cycle count for each instruction calculated by the bus model unit.

3. The simulation apparatus according to claim 2, further comprising:
an instruction cache unit that functions as a cache for the memory,
wherein the bus model unit accepts the access request to the memory from the bus interface unit, for each instruction of the program, and
wherein when accepting a load request for data of an operand used in an instruction of the program as the access request to the memory, the bus interface unit performs the load request to the bus model unit if the data of the operand is not stored in the instruction cache unit, and does not perform the load request to the bus model unit if the data of the operand is stored in the instruction cache unit.

4. The simulation apparatus according to claim 2,
wherein the bus model unit accepts the access request to the memory from the bus interface unit and accepts the access request to the memory from other than the bus interface unit, for each instruction of the program, and while one access request is being processed, determines that the bus is being used.

5. The simulation apparatus according to claim 1, further comprising:
a memory interface unit that accepts an access request to the memory from the bus model unit, and outputs an access delay to the memory as a predetermined cycle count of the processor, for each instruction of the program,
wherein when accepting the access request to the memory, the bus model unit performs the access request to the memory interface unit without waiting until use of the bus is granted, and
wherein the cycle count accumulation unit computes the cycle count required for executing the program based on the cycle count for each instruction output by the memory interface unit, in addition to the cycle count for each instruction calculated by the bus model unit.

6. The simulation apparatus according to claim 1, further comprising:
a memory access latency database that stores an access delay to the memory as a cycle count of the processor for each address range of the memory; and
a memory interface unit that accepts an access request to the memory, and extracts from the memory access latency database a cycle count corresponding to a relevant address in the memory, for each instruction of the program,
wherein the cycle count accumulation unit computes the cycle count required for executing the program based on the cycle count for each instruction extracted by the memory interface unit, in addition to the cycle count for each instruction calculated by the bus model unit.

7. The simulation apparatus according to claim 1,
wherein, as the program, the memory stores data of each instruction of the program and stores data of an operand used in each instruction of the program, and
wherein the bus model unit accepts either of a load request for data to be loaded from the memory or a store request for data to be stored to the memory as the access request to the memory, for each instruction of the program.

8. A simulation method by which a simulation of a program for executing a plurality of instructions included in an instruction set of a processer is performed, the simulation method comprising:
by a bus model unit, accepting an access request to a memory storing the program, performing a simulation of arbitration for a bus, and calculating a cycle count of the processor until use of the bus is granted, for each instruction of the program; and
by a cycle count accumulation unit, computing a cycle count required for executing the program based on the cycle count for each instruction calculated by the bus model unit.
